(19) United States
(12) Patent Application Publication
(10) Pub. No.: US 2023/0272246 A1
(43) Pub. Date: Aug. 31, 2023

(54) THIOL-BASED ADHESIVE FORMULATIONS FOR REPAIRING WINDSHIELDS

(71) Applicant: Mondofix Inc., Blainville (CA)

(72) Inventor: Penny M. CHATTERTON, Shakopee, MN (US)

(73) Assignee: Mondofix Inc., Blainville, QC (CA)

(21) Appl. No.: 17/625,235

(22) PCT Filed: Jul. 10, 2020
(86) PCT No.: PCT/CA2020/050964

§ 371 Date: Jan. 6, 2022

Related U.S. Application Data
(60) Provisional application No. 62/873,208, filed on Jul. 12, 2019.

(51) Int. Cl. C09J 7/38; C08K 5/37; C09J 7/20; B29C 73/02

(52) U.S. Cl. CPC C09J 7/385; C08K 5/37; C09J 7/20; B29C 73/025

(57) ABSTRACT

Disclosed herein are adhesive compositions containing a polythiol compound, a (meth)acrylate monomer and/or a (meth)acrylate oligomer, a photoinitiator, and a stabilizer. These thiol-based adhesive compositions have a viscosity in the 5-100 cP range, and can be used to repair chips, cracks, and other damaged areas of a glass or automobile windshield.

This application is being filed on Jul. 12, 2020, as a PCT International application and claims the benefit of priority to U.S. Provisional Patent Application No. 62/873,208, filed on Jul. 12, 2019, the disclosure of which is incorporated herein by reference in its entirety.

### FIELD OF THE INVENTION

The present disclosure relates to UV-curable thiol-based adhesive formulations, and more particularly, relates to the use of such formulations to repair cracks, chips, and other types of damage to glass windshields.

### BACKGROUND OF THE INVENTION

There are numerous adhesive formulations and repair systems that can be used to fix a damaged area of a glass windshield. However, optical consistency with the glass is not always acceptable, and the repaired area often is visually distinguishable from the rest of the glass. Thus, it would be beneficial to develop adhesive formulations with a closer optical match to that of the windshield glass. Accordingly, it is to these ends that the present invention is generally directed.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Adhesive compositions are disclosed and described herein. One such composition can comprise (i) a polythiol compound, (ii) a (meth)acrylate monomer and/or a (meth)acrylate oligomer, (iii) a photoinitiator, and (iv) a stabilizer. Optionally, other components can be present in the adhesive composition, such as an olefin compound, a UV inhibitor, and an adhesive promoter. Beneficially, the adhesive composition can have a viscosity suitable for flowing in and around cracks and other types of damage in automotive glass windshields, and often this viscosity (at 22.5° C.) ranges from about 5 to about 100 cP, from about 10 to about 50 cP, or from about 17 to about 40 cP.

After curing the adhesive composition, the cured adhesive can be characterized by a refractive index in a range from about 1.52 to about 1.55, and more typically, from about 1.53 to about 1.54, or from about 1.5325 to about 1.5375.

Methods for repairing a damaged area of a windshield also are provided by the present invention. An illustrative method for repairing the damaged area of the windshield can comprise (A) introducing the thiol-based adhesive composition into the damaged area, and (B) curing the composition to repair the damaged area of the windshield.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURE

FIG. 1 presents a bar chart of the refractive index of comparative adhesives (not thiol-based adhesives) for repairing automobile windshields.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the designs, compositions, processes, or methods described herein are contemplated with or without explicit description of the particular combination. Additionally, unless explicitly recited otherwise, any aspect and/or feature disclosed herein can be combined to describe inventive designs, compositions, processes, or methods consistent with the present disclosure.

While compositions and methods/processes are described herein in terms of “comprising” various components or steps, the compositions and methods/processes also can “consist essentially of” or “consist of” the various components or steps, unless stated otherwise. For example, an adhesive composition consistent with aspects of the present invention can comprise; alternatively, can consist essentially of; or alternatively, can consist of; a polythiol compound, a (meth)acrylate monomer and/or a (meth)acrylate oligomer, a photoinitiator, and a stabilizer.

The terms “a,” “an,” “the,” etc., are intended to include plural alternatives, e.g., at least one, unless otherwise specified. For instance, the disclosure of “a polythiol compound” or “a stabilizer” is meant to encompass one, or mixtures or combinations of more than one, polythiol compound or stabilizer, respectively, unless otherwise specified.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular compound disclosed herein, the general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane, while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires.

The terms “adhesive composition,” “adhesive formulation,” “adhesive mixture,” and the like, do not depend upon the actual product or composition resulting from the contact or reaction of the initial components of the disclosed or claimed adhesive composition/formulation/mixture, or the fate of the polythiol compound, the (meth)acrylate monomer and/or the (meth)acrylate oligomer, the photoinitiator, or the stabilizer, after combining these components. Therefore, the terms “adhesive composition,” “adhesive formulation,” “adhesive mixture,” and the like, encompass the initial starting components of the composition, as well as whatever product(s) may result from combining or contacting these initial starting components, and this is inclusive of any contact time or storage time (e.g., immediately after forming the composition, the composition after storage for 3 months, etc.). The components of the adhesive composition can be blended or mixed together in any order, in any suitable manner, and by any method suitable for contacting or combining the components to form the composition. The terms “adhesive composition,” “adhesive formulation,” “adhesive mixture,” and the like, can be used interchangeably throughout this disclosure.

Although any methods, devices, and materials similar or equivalent to those described herein can be used in the practice or testing of the invention, the typical methods, devices, and materials are herein described.

All publications and patents mentioned herein are incorporated herein by reference for the purpose of describing and disclosing, for example, the constructs and methodologies that are described in the publications, which might be used in connection with the presently described invention.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. As a representative example, the adhesive formulation can have a viscosity at 22.5° C. in certain ranges in various aspects of this invention. By a disclosure that the viscosity can be in a range from about 10 to about 50 cP, the intent is to recite that the viscosity can be any value within the range and, for example, can be equal to about 10, about 15, about 20, about 25, about 30, about 35, about 40, about 45, or about 50 cP. Additionally, the viscosity can be within any range from about 10 to about 50 cP (for example, from about 17 to about 40), and this also includes any combination of ranges between about 10 and about 50 cP (for example, the viscosity can be in a range from about 10 to about 20 cP, or from about 25 to about 42 cP). Further, in all instances, where “about” a particular value is disclosed, then that value itself is disclosed. Thus, the disclosure of a viscosity range from about 10 to about 50 cP also discloses a viscosity range from 10 to 50 cP (for example, from 17 to 40), and this also includes any combination of ranges between 10 and 50 cP (for example, the viscosity can be in a range from 10 to 20 cP, or from 25 to 42 cP). Likewise, all other ranges disclosed herein should be interpreted in a manner similar to this example.

The term “about” means that amounts, sizes, formulations, parameters, and other quantities and characteristics are not and need not be exact, but can be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture of components. Whether or not modified by the term “about,” the claims include equivalents to the quantities. The term “about” can mean within 10% of the reported numerical value, preferably within 5% of the reported numerical value.

### DETAILED DESCRIPTION

The present invention is directed generally to thiol-based adhesive compositions, cured adhesives formed from these adhesive compositions, and methods for repairing damaged areas of a windshield using these adhesive compositions.

Conventional adhesive formulations used in windshield repair are based on (meth)acrylate UV-initiated radical cure chemistry, but such adhesive formulations have drawbacks. First and foremost, they do not exhibit a close optical match to windshield glass, as quantified by the refractive index. Once cured, the repaired area for many types of glass damage is readily noticeable and distinguishable from the undamaged portions of the glass. Further, these windshield repair adhesive formulations often have excessive cure shrinkage, which must be compensated for during the cure process. Although shrinkage can be minimized, the curing process can induce residual shrinkage stress in the bond area, and the damaged area may re-open as the glass flexes due to strains or temperature swings.

Unexpectedly, the thiol-based adhesives disclosed herein impart a higher refractive index to the cured adhesive, resulting in a better optical match with the glass windshield. This is particularly important when a repair is made in the optical path of a camera which is used as part of an advanced driver assist system. A repair using a cured adhesive which matches the refractive index of a windshield laminate, while also exhibiting minimal birefringence, is less likely to disturb the proper functioning of the camera, and thus will not disable or interfere with the driver assist system.

### Adhesive Compositions

In some aspects, the present invention encompasses adhesive compositions comprising a polythiol compound (one or more than one), a (meth)acrylate monomer and/or a (meth)acrylate oligomer (one or more than one), a photoinitiator (one or more than one), and a stabilizer (one or more than one). Optionally, other components, materials, or additives can be present, such as described further hereinbelow.

As used herein, the “polythiol” compound in the adhesive formulation refers to compounds containing at least two thiol (—SH) groups. In one aspect, for instance, the polythiol compound contains two thiol (—SH) groups, while in another aspect, the polythiol compound contains three thiol (—SH) groups, and in yet another aspect, the polythiol compound contains four thiol (—SH) groups. As noted above, more than one polythiol compound can be used, thus mixtures or combinations of polythiol compounds having any suitable number of thiol groups are encompassed herein.

Illustrative and non-limiting examples of polythiol compounds that can be employed in adhesive formulations consistent with this invention can include 1,2-ethanedithiol, 1,8-dimercapto-3,6-dioxaoctane, glycol di(3-mercaptopropionate), trimethylolpropane tris(3-mercaptopropionate), pentaerythritol tetrakis(3-mercaptopropionate), dipentaerythritol hexakis(3-mercaptopropionate), ditrimethylolpropane tetrakis(3-mercaptopropionate), glycol dimercaptoacetate, trimethylolpropane trimercaptoacetate, pentaerythritol tetramercaptoacetate, an ethoxylated trimethylolpropane tris(3-mercaptopropionate), propylene glycol (3-mercaptopropionate), 2,3-di((2-mercaptoethyl)thio)-1-propanethiol, dimercaptodiethyl sulfide, tris[2-(3-mercaptopropionyloxy)ethyl]isocyanurate, pentaerythritol tetrakis(thioglycolate), pentaerythritol tetrakis(3-mercaptopropyl ether), and the like, as well as any combination thereof. In some aspects, the polythiol compound can comprise trimethylolpropane tris(3-mercaptopropionate), pentaerythritol tetrakis(3-mercaptopropionate), glycol dimercaptoacetate, or any combination thereof, while in other aspects, the polythiol compound can comprise trimethylolpropane tris(3-mercaptopropionate); alternatively, pentaerythritol tetrakis(3-mercaptopropionate); or alternatively, glycol dimercaptoacetate.

Referring now to the (meth)acrylate monomer and/or the (meth)acrylate oligomer component of the adhesive formulation, it is contemplated that the (meth)acrylate monomer can be used (and more than one monomer can be used), or the (meth)acrylate oligomer can be used (and more than one oligomer can be used), or a mixture or combination of the (meth)acrylate monomer and the (meth)acrylate oligomer can be used (and more than one monomer and/or more than one oligomer can be used).

Illustrative and non-limiting examples of (meth)acrylate monomers that can be employed in the disclosed adhesive formulations can include isobornyl acrylate, isobornyl methacrylate, 2-hydroxyethyl acrylate, 2-hydroxyethyl methacrylate, 4-hydroxybutyl acrylate, hydroxybutyl methacrylate, hydroxypropyl acrylate, hydroxypropyl methacrylate, tetrahydrofurfuryl acrylate, tetrahydrofurfuryl methacrylate, dodecyl acrylate, phenyl glycidyl ether acrylate, 2-(2-ethoxyethoxy)ethyl acrylate, 2-ethylhexyl acrylate, 2-ethoxyethyl acrylate, 2-butoxyethyl acrylate, 2-naphthyl acrylate, butyl acrylate, lauryl acrylate, trimethylsilyl acrylate, 2-hydroxy-3-phenoxypropyl acrylate, 2,2,3,3,3,-pentafluoropropyl acrylate, glycidyl acrylate, glycidyl methacrylate, dicyclopentenyl acrylate, and the like, as well as any combination thereof.

Other suitable (meth)acrylate monomers can include, but are not limited to, an ethylene glycol diacrylate, a di(ethylene glycol) diacrylate, a tetra(ethylene glycol) diacrylate, a poly(ethylene glycol) diacrylate, an ethylene glycol dimethacrylate, a di(ethylene glycol) dimethacrylate, a poly(ethylene glycol) dimethacrylate, a pentaerythritol triacrylate, a trimethylolpropane triacrylate, a pentaerythritol propoxylate triacrylate, a trimethylol propane ethoxylate triacrylate, a trimethylolpropane propoxylate triacrylate, a trimethylolpropane trimethacrylate, a di(trimethylolpropane) tetraacrylate, a pentaerythritol tetraacrylate, a dipentaerythritol pent-/hexa-acrylate, and the like, as well as any combination thereof.

In one aspect, the (meth)acrylate monomer can comprise benzyl methacrylate, hydroxyethyl methacrylate, isobornyl (meth)acrylate, a C₄-C₁₂ linear or branched alkyl (meth)acrylate, a C₆-C₁₂ cyclic (meth)acrylate, or any combination thereof. In another aspect, however, the (meth)acrylate monomer can comprise isobornyl acrylate, isobornyl methacrylate, 2-hydroxyethyl acrylate, 2-hydroxyethyl methacrylate, or dicyclopentenyl acrylate, either singly or in any combination.

As to suitable (meth)acrylate oligomers, representative examples include a polyester of hexanedioic acid and diethylene glycol, terminated with isophorone diisocyanate, capped with 2-hydroxyethyl acrylate; a polypropylene glycol terminated with toluene-2,6-diisocyanate, capped with 2-hydroxyethylacrylate; a polyester of hexanedioic acid and diethylene glycol, terminated with 4,4′-methylenebis(cyclohexyl isocyanate), capped with 2-hydroxyethyl acrylate; a polyester of hexanedioic acid, 1,2-ethanediol, and 1,2 propanediol, terminated with toluene-2,4-diisocyanate, capped with 2-hydroxyethyl acrylate; a polyester of hexanedioic acid, 1,2-ethanediol, and 1,2 propanediol, terminated with 4,4′-methylenebis(cyclohexyl isocyanate), capped with 2-hydroxyethyl acrylate; a polyester of hexanedioic acid, diethylene glycol, terminated with isophorone diisocyanate, capped with 2-hydroxyethyl acrylate, a polytetramethylene glycol ether terminated with 4,4′-methylene bis(cyclohexylisocyanate), capped with 2-hydroxyethyl acrylate; a hydroxy terminated polybutadiene terminated with isophorone diisocyanate, capped with 2-hydroxyethyl acrylate; and the like, as well as any combination thereof.

The (meth)acrylate oligomers are not limited to those provided above. For example, other suitable (meth)acrylate oligomers can comprise a polypropylene terminated with 4,4′-methylenebis (cyclohexylisocyanate), capped with 2-hydroxyethyl acrylate and 1-docosanol; a polytetramethylene glycol ether terminated with toluene-2,4-diisocyanate, capped with 2-hydroxyethyl methacrylate; a polytetramethylene glycol ether terminated with isophorone diisocyanate, capped with 2-hydroxyethyl methacrylate; a polytetramethylene glycol ether terminated with 4,4′-methylenebis(cyclohexylisocyanate), capped with 2-hydroxyethyl methacrylate; a polypropylene glycol terminated with toluene-2,4-diisocyanate, capped with 2-hydroxyethyl methacrylate; and the like, as well as any combination thereof.

Suitable (meth)acrylate monomer and (meth)acrylate oligomer materials are not limited solely to those provided herein. Other suitable monomers/oligomers are commercially available from Sartomer Americas.

Any suitable photoinitiator can be used in the adhesive formulation. Illustrative examples can include, but are not limited to, benzophenone, Michler's ketone, benzoin methyl ether, benzoin ethyl ether, 2-hydroxy-2-methylpropiophenone, 1-hydroxycyclohexyl phenyl ketone (Irgacure® 184), 2,2-diethoxyacetophenone, camphorquinone, 2-ethylanthraquinone, 2-tert-butylanthraquinone, 2,3-dichloro-1,4-naphthoquinone, 2-hydroxy-4′-(2-hydroxyethoxy)-2-methylpropiophenone, methyl benzoylformate, 2,2-dimethoxy-2-phenylacetophenone, 2-ethylhexy-4-(dimethylamino)benzoate, 2-ethyl-4-(dimethylamino)benzoate, 2-isopropylthioxanthone, 4-phenylbenzophenone, 2-benzyl-2-(dimethylamino)-4′-morpholinobutyrophenone, diphenyl(2,4,6-trimethylbenzoyl) phosphine oxide, phenylbis(2,4,6-trimethylbenzoyl) phosphine oxide, and the like, as well as any combination thereof. In some aspects, the photoinitiator can comprise 1-hydroxycyclohexyl phenyl ketone; alternatively, diphenyl(2,4,6-trimethylbenzoyl) phosphine oxide; or alternatively, phenylbis(2,4,6-trimethylbenzoyl) phosphine oxide.

As to the stabilizer component of the adhesive formulation, it is contemplated that an antioxidant component can be used (and more than one antioxidant can be used), or an acidic component can be used (and more than one acidic component can be used), or a mixture or combination of an antioxidant component and an acidic component can be used (and more than one antioxidant and/or more than one acidic component can be used).

Generally, any suitable antioxidant can be used as the stabilizer. For instance, representative and non-limiting examples include hydroquinone, p-tert-butyl catechol, 2,6-di-tert-butyl-p-methylphenol, phenothiazine, N-phenyl-2-naphthylamine, butylated hydroxytoluene (BHT), and the like, as well as any combination thereof.

Acidic components that can be used as the stabilizer, either alone or in combination with an antioxidant component, can include phosphorus-containing acids (e.g., phosphoric acid, phosphorous acid), organic acids, or combinations thereof. Representative organic acids include acrylic acid, methacrylic acid, maleic acid, fumaric acid, cinnamic acid, cyanoacetic acid, barbituric acid, citric acid, ascorbic acid, and the like, as well as combinations thereof. In some aspects consistent with this invention, the stabilizer can comprise butylated hydroxytoluene (BHT), a phosphorus-containing acid, acrylic acid, methacrylic acid, or any combination thereof.

Generally, the relative amounts of the polythiol, (meth)acrylate monomer/oligomer, photoinitiator, and stabilizer components of the adhesive formulation are not particularly limited, so long as an adhesive is formed with suitable adhesion, viscosity, refractive index, and shelf-life properties. Nonetheless, based on the total weight of the adhesive composition, the adhesive composition normally contains from about 5 to about 75 wt. % of the polythiol compound, such as from about to about 60 wt. %, from about 10 to about 40 wt. %, or from about 10 to about 25 wt. %.

In most instances, the majority of the adhesive composition is the (meth)acrylate monomer and/or the (meth)acrylate oligomer. The total amount of the (meth)acrylate monomer and the (meth)acrylate oligomer present in the composition often falls in the range of about 50 to about 85 wt. %. Illustrative ranges for the total amount of the (meth)acrylate monomer and the (meth)acrylate oligomer present in the composition include from about 50 to about 80 wt. %, from about 55 to about 85 wt. %, from about 55 to about 80 wt. %, from about 60 to about 80 wt. %, or from about 65 to about 75 wt. %.

The photoinitiator and stabilizer components are present in the adhesive formulation in minor amounts, generally ranging from about 100 ppm (by weight) up to about 2 wt. %. Representative ranges for the respective amounts of the photoinitiator component and the stabilizer component in the composition include from about 500 ppm to about 2 wt. %, from about 2500 ppm to about 1.5 wt. %, or from about 5000 ppm to about 1.5 wt. %.

Optionally, the adhesive composition can further comprise an olefin compound, i.e., an olefin compound different from the (meth)acrylate monomer and (meth)acrylate oligomer described hereinabove. In one aspect, the olefin compound can be a mono-olefin, while in another aspect, the olefin compound can be a di-olefin, and in yet another aspect, the olefin compound can be a tri-olefin.

Any suitable olefin compound can be used in the adhesive formulation. Illustrative examples can include, but are not limited to, diallyl phthalate, n-vinyl pyrrolidone, an acrylamide, a vinyl ether (e.g., a divinyl ether or trivinyl ether), a vinyl ester, and the like, as well as any combination thereof. In some aspects, the olefin compound can comprise 1-vinyl-2-pyrrolidone, N-(hydroxymethyl)acrylamide, diacetone acrylamide, N-hydroxyethyl acrylamide, N-(isobutoxymethyl)acrylamide, N-(3-methoxypropyl)acrylamide, N-[tris(hydroxymethyl)methyl]acrylamide, 3-(acrylamido)phenylboronic acid, an alkylacrylamide, N,N-dimethylacrylamide, N-isopropylacrylamide, N-tert-butylacrylamide, N,N-diethylacrylamide, N-acryloyl-L-valine, N,N-diethylmethacrylamide, butyl vinyl ether, propyl vinyl ether, 1,4-butanediol vinyl ether, isobutyl vinyl ether, phenyl vinyl ether, tert-butyl vinyl ether, cyclohexyl vinyl ether, 1,4-cyclohexanedimethanol vinyl ether, 2-ethylhexyl vinyl ether, 2-chloroethyl vinyl ether, dodecyl vinyl ether, ethylene glycol vinyl ether, di(ethylene glycol) vinyl ether, n-butyl vinyl ether, hexadecyl vinyl ether, isooctyl vinyl ether, methyl 1-vinyl-4-oxatricyclo[4.4.0.0(3,8)]dec-3-yl ether, tri(ethylene glycol) divinyl ether, vinyl propionate, vinyl decanoate, vinyl neodecanoate, or any combination thereof.

Other vinyl ethers can be used as the olefin compound, commercially available examples of which include Vectomer® 1312 vinyl ether, Vectomer® 2032 vinyl ether, Vectomer® 2010 vinyl ether, and Vectomer® 2031 vinyl ether.

When an olefin compound is present in the adhesive composition, the composition often contains from about 50 to about 85 wt. % of the olefin compound and the (meth)acrylate monomer and/or the (meth)acrylate oligomer (in total). Illustrative ranges for the total amount of the olefin compound, (meth)acrylate monomer, and (meth)acrylate oligomer present in the composition include from about 50 to about 80 wt. %, from about 55 to about 85 wt. %, from about 55 to about 80 wt. %, from about 60 to about 80 wt. %, or from about 65 to about 75 wt. %.

While not being limited thereto, the weight ratio of the (meth)acrylate monomer and/or the (meth)acrylate oligomer to the olefin compound in the adhesive composition often ranges from about 1:1 to about 10:1, such as, for example, from about 1.5:1 to about 8:1, from about 2:1 to about 7:1, or from about 2:1 to about 5:1.

Optionally, the adhesive composition can further comprise a UV inhibitor, also referred to as a UV stabilizer, UV absorber, or light stabilizer. Typical commercially-available UV inhibitors that can be used in the disclosed adhesive compositions include N-(2-ethoxyphenyl-N′-(2-ethylphenyl) ethanediamide; 2-[4-[(2-hydroxy-3-dodecyloxypropyl)oxy]-2-hydroxyphenyl]-4,6-bis(2,4-dimethylphenyl)-1,3,5-triazine and/or 2-[4-[(2-hydroxy-3-tridecyloxypropyl)oxy]-2-hydroxyphenyl]-4,6-bis(2,4-dimethylphenyl)-1,3,5-triazine; 2-(2H-benzotriazol-2-yl)-6-(1-methyl-1-phenylethyl)-4-(1,1,3,3-tetramethylbutyl)phenol; benzenepropanoic acid, 3-(2H-benzotriazol-2-yl)-5-(1,1,dimethylethyl)-4-hydroxy-, C7-C9-branched and linear alkyl esters; phenol, 2-(5-chloro-2H-benzotriazol-2-yl)-6-(1,1,-dimethylethyl)-4-methyl-; alpha-[3-[3-(2H-benzotriazol-2-yl)-5-(1,1-dimethylethyl)-4-hydroxyphenyl]-1-oxopropyl]-omega-hydroxypoly(oxo-1,2-ethanediyl) and/or alpha-[3-[3-(2H-benzotriazol-2-yl)-5-(1,1-dimethylethyl)-4-hydroxyphenyl]-1-oxopropyl]-omega-[3-[3-(2H-benzotriazol-2-yl)-5-(1,1-dimethylethyl)-4-hydroxyphenyl]-1-oxopropoxy]poly(oxo-1,2-ethanediyl); 2-(2H-benzotriazol-2-yl)-p-cresol; bis(1,2,2,6,6-pentamethyl-4-piperidinyl) sebacate and/or methyl(1,2,2,6,6,-pentamethyl-4-piperidinyl) sebacate; decanedioic acid, bis(2,2,6,6-tetramethyl-1-(octyloxy)-4-piperidinyl) ester, reaction products with 1,1-dimethylethylhydroperoxide and octane; bis(2,2,6,6-tetramethyl-4-piperidinyl) sebacate; hexanoic acid, 3,5,5-trimethyl-, 2,2,6,6-tetramethyl-1-(2-((3,5,5-trimethyl-1-oxohexyl)oxy)ethyl)-4-piperidinyl ester; and the like, as well as combinations thereof.

When present, the UV inhibitor component is present in the adhesive formulation in a minor amount, generally ranging from about 100 ppm (by weight) up to about 2 wt. %. Representative ranges in the composition include from about 500 ppm to about 2 wt. %, from about 1500 ppm to about 1.5 wt. %, or from about 2500 ppm to about 1.5 wt. %.

Optionally, the adhesive composition can further comprise an adhesion promoter. Examples of adhesion promoter include, but are not limited to, maleic acid, acrylic acid, itaconic acid, a silane, and the like, as well as combinations thereof. Non-limiting examples of suitable silanes include (3-methacryloxypropyl) trimethoxysilane, (3-acryloxypropyl) trimethoxysilane, methacryloxypropyl triethoxysilane, (3-glycidoxypropyl) trimethoxysilane, 3-acrylamidopropyl trimethoxysilane, 3-methacrylamidopropyl trimethoxysilane, (acryloxymethyl)phenethyl trimethoxysilane, acryoxymethyl trimethoxysilane, meta-allylphenylpropyl triethoxysilane, meta-allylphenylpropyl trimethoxysilane, 3-mercaptopropyl trimethoxysilane, 3-mercaptopropyl triethoxysilane, vinyltrimethoxysilane, and the like, as well as any combination thereof.

When present, the adhesion promoter is present in the adhesive formulation at an amount in a range from about 1 to about 18 wt. %. Representative ranges in the composition include from about 2 to about 15 wt. %, from about 1 to about 10 wt. %, or from about 5 to about 12 wt. %.

Although not limited thereto, the adhesive composition often has a Brookfield viscosity at 22.5° C. that ranges from about 5 to about 100 cP. More typically, and beneficially, the adhesive composition has a viscosity at the lower end of this range, such as a Brookfield viscosity at 22-23° C. from about 10 to about 50 cP, from about 12 to about 45 cP, or from about 17 to about 40 cP.

Prior to curing of the adhesive composition, the disclosed adhesive compositions can be characterized by a refractive index in a range from about 1.46 to about 1.50, and in some instances, from about 1.48 to about 1.495, or from about 1.485 to about 1.495. These uncured refractive index values are unexpectedly higher than that of traditional adhesive formulations, which do not contain a polythiol component.

The adhesive composition also is configured to have a surface tension such that the composition can readily flow into a damaged area of a glass article, such as a windshield.

Beneficially, the adhesive composition can be shelf-stable for at least 2 months at 25° C. and 1 atm. For instance, the adhesive composition can be shelf-stable for at least 3 months at 25° C. and 1 atm, at least 6 months at 25° C. and 1 atm, at least 9 months at 25° C. and 1 atm, or at least 12 months at 25° C. and 1 atm. Shelf-stability generally is limited by thickening of the adhesive composition to a point at which the viscosity is too high or above a workable range (125 cP).

### Cured Adhesives and Articles

Cured adhesives produced from any of the above-described adhesive compositions also are encompassed herein. Beneficially, the cured adhesives have unexpectedly higher indices of refraction, and are more compatible with glass and automobile windshields (e.g., 1.535 is a desirable refractive index for use in many windshield applications). Herein, the cured adhesive can be characterized by a refractive index in a range from about 1.52 to about 1.55, and in some instances, from about 1.53 to about 1.54, from about 1.53 to about 1.5375, from about 1.53 to about 1.535, or from about 1.5325 to about 1.5375.

The cured adhesive has excellent adhesion to glass. While not limited thereto, the cured adhesive can have a glass adhesion strength in a range from about 2000 to about 8000 psi, such as from about 4000 to about 6000 psi. The cured adhesive composition also is configured to have a shrinkage such that the planar stability is maintained. If the shrinkage is excessive, the cured adhesive can result in curl, which is to be avoided.

Articles of manufacture can be formed from, and/or can comprise, the cured adhesive of this invention. As an example, an illustrative article of manufacture consistent with this disclosure can comprise a substrate partially filled with any of the cured adhesives provided herein. In one aspect, the substrate can comprise glass, while in another aspect, the substrate is an automobile windshield.

### Methods for Repairing Windshields

Various methods for repairing a damaged area of a windshield are disclosed and described herein. One such method for repairing the damaged area of the windshield can comprise (A) introducing any of the adhesive compositions disclosed herein into the damaged area, and (B) curing the composition to repair the damaged area of the windshield.

Generally, the features of any of the methods disclosed herein (e.g., the damaged area, the adhesive composition, and the curing conditions (e.g., UV curing), among others) are independently described herein, and these features can be combined in any combination to further describe the disclosed methods. Moreover, other process steps can be conducted before, during, and/or after any of the steps listed in the disclosed methods, unless stated otherwise. Additionally, repaired windshields formed or produced in accordance with the disclosed methods are within the scope of this disclosure and are encompassed herein.

In this disclosure, the “damaged area” of the windshield is meant to encompass any type of damage, which often can be described as a crack, a chip, a bulls-eye, a pock mark, a star break, a defect, or any other suitable description known to those of skill in the art.

Referring now to step (A), step (A) of the method is directed to introducing the adhesive composition into the damaged area, and “introducing” is meant to encompass applying, injecting, filling, or any other manner or technique in which the adhesive composition is contacted with the damaged area. The “curing” in step (B) can employ any suitable technique, but often, the adhesive is UV-cured to repair the damaged area of the windshield.

The method for repairing the damaged area of the windshield can be performed at a variety of temperatures and time periods. For instance, step (A) and step (B), independently, can be conducted a temperature in a range from about 10 to about 35° C.; alternatively, from about 15° C. to about 30° C.; or alternatively, from about 20° C. to about 25° C. In these and other aspects, these temperature ranges also are meant to encompass circumstances where step (A) and/or step (B) is/are conducted at a series of different temperatures, instead of at a single fixed temperature, falling within the respective ranges, wherein at least one temperature is within the recited ranges. Generally, ambient temperatures are conveniently used for the methods described herein, and both excessively high and low temperatures are typically avoided.

The duration of step (B) is not limited to any particular period of time (the curing time), however, step (B) can be conducted in a time period that can be in a range from about 30 sec to about 2 hr, such as, for example, from about 1 min to about 1 hr, from about 2 min to about 45 min, from about 2 min to about 10 min, from about 3 min to about 30 min, and the like.

Depending upon the size and the extent of the damaged area, the amount of the adhesive composition introduced in step (A) can vary significantly. Nonetheless, the amount of the adhesive composition introduced into the damaged area in step (A) often falls in a range from about 0.05 to about 0.15 grams, and more often, from about 0.06 to about 0.12 grams.

Optionally, the methods disclosed herein can further comprise a step of removing air from the damaged area before step (A), and any suitable technique can be utilized. Often, this is accomplished by applying a vacuum or using any suitable sub-atmospheric pressure. Also, if desired, the methods disclosed herein can further comprise a step of removing any excess amount of the adhesive composition from around and/or above the damaged area after step (A) and before step (B).

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Gel time and immediate adhesion evaluation were determined at a laboratory temperature of 72° F. A drop of resin was sandwiched between the ends of two microscope slides placed at right angles to one another, ensuring that the resin wetted out the entire overlap area. A curing lamp was placed over the overlap area and a timer and lamp were started simultaneously. The upper microscope slide was moved gently back and forth until the bottom slide began to move with it. The elapsed time (seconds) was recorded as the gel time of the formulation. The sample was then allowed to cure for 5 minutes. The cured sample was attempted to be broken by twisting the free ends of the adhered slides in opposite directions. It was noted whether the cured adhesive bond breaks or the glass slide breaks.

The refractive index (n_{d}) of the cured adhesive and the uncured formulation were determined using a Reichert Abbé Mark II refractometer. Measurement temperature was 22.5° C. (+/−1.5° C.). Liquid uncured formulations were analyzed by placing one drop of the formulation directly upon the measurement crystal of the refractometer.

To create a film of the cured adhesive, a sample of the adhesive formulation (e.g., approximately 0.05 mL) to result in a free-standing film less than 0.010″ thick once cured, was placed between two 0.0065″ (0.0165 cm) thick pieces of flat transparent Mylar™ plastic, which at maximum conform to the dimensions of the testing area of the refractometer. The adhesive formulation was then cured between the layers of Mylar by a suitable UV-emitting lamp, such as a lamp emitting 365 nm radiation at 300 mW/cm². The thickness of the resulting resin film is not always uniform, but was typically 6.5 mils (+/−3.5 mils). Four (4) measurements were taken, and the average reported, as well as the thickness or thickness range.

The cured film was laid on the sample crystal over a suitable high refractive index liquid (bromonaphthalene). This allows the light/shadow demarcation which indicates the refractive index to be easily seen. It may be informative to rotate the usually square or rectangular sample to determine the variation in refractive index due to orientation.

Glass adhesion strength was determined using 4-inch long pieces of 6 mm diameter Pyrex rods, which were carefully scribed and broken in half to give uniform flat surfaces for bonding. The two sides were marked before breaking to allow for easy re-orientation. A small amount of the adhesive formulation (i.e., one drop) was placed between the two surfaces and they were adhered via curing with a suitable UV-emitting lamp. Excess adhesive was removed. The two ends of the sample were then mounted into appropriate fixtures for tensile testing with a suitable universal tester. Crosshead speed was 0.2 inch/minute. The strength at break and the type of break (adhesive (A), cohesive (C), or glass (G)) were determined.

A Brookfield cone and plate viscometer was used to measure the viscosity of liquid formulations. Measurement temperature was 22.5° C. (+/−0.5° C.), and the rotational speed was 60 rpm. The specific model used was a Brookfield DV-II cone and plate viscometer, spindle 52 (60 rpm).

The linear shrinkage of the adhesive during curing was determined as follows. Three 100 μL microcapillary tubes were lubricated inside with a hydrocarbon lubricant (e.g., Stoner Penetrating Lube). The liquid adhesive formulation was allowed to flow into the capillary from a test tube reservoir, to a prescribed length of approximately 2.5 inches. The actual length was measured to three decimal places with a digital caliper having at least 0.001″ accuracy. The three samples were cured simultaneously by a commercial UV-emitting lamp, and the length of the cured formulation was re-measured. The average change in length was recorded as a percentage of the original length (shrinkage).

### Examples 1-2

Comparison of a Standard Adhesive Formulation with a Thiol-Based Formulation

Table I summarizes the formulations of Examples 1-2. Example 1 used 18 g of a polythiol compound—trimethylolpropane tris(3-mercaptopropionate), structure shown below—while Comparative Example 2 did not contain a polythiol. Instead, Comparative Example 2 used 18 g of trimethylolpropane triacrylate, structure shown below.

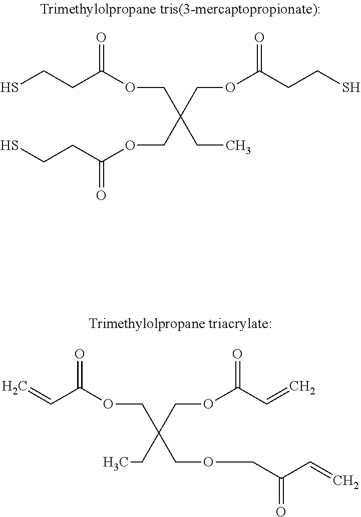 [SMILES: CCC(COC(=O)CCS)(COC(=O)CCS)COC(=O)CCS ; C=CC(=O)COCC(CC)(COC(=O)C=C)COC(=O)C=C]

For these examples, the respective components were combined in any order at a temperature of 22-23° C., and mixed for approximately 1 hour. The thiol-based formulation of Example 1 contained approximately 17-18 wt. % of the polythiol compound, 71 wt. % of (meth)acrylate monomers/oligomers, 1 wt. % of the photoinitiator, 1 wt. % of the stabilizer components, 9.5 wt. % of the adhesion promoter, and 0.2 wt. % of the UV inhibitor.

As shown in Table II, the thiol-based formulation of Example 1 had equivalent viscosity to that of Comparative Example 2, but beneficially, a higher uncured refractive index. After curing, the thiol-based formulation of Example 1 had an unexpectedly high refractive index of 1.5305, much higher than that of Comparative Example 2. Further, the glass adhesion strength of Example 1 was far superior to that of Comparative Example 2.

### Examples 3-15

### Additional Thiol-Based Formulations

Examples 3-15 were performed in a manner similar to that of Example 1. Table I summarizes the formulations of Examples 3-15, and Table II summarizes the properties of Examples 3-15. With the exception of Example 15, the viscosities of the formulations of Examples 3-15 ranged from 19 to 47 cP. Cured refractive index values for Examples 3-15 ranged from 1.527 to 1.539, with several examples having refractive index values of 1.535+/−0.002.

### Examples 16-17

### Additional Refractive Index Data

In Example 16, similarly structured acrylates were compared to thiols for their uncured refractive index values: pentaerythritol tetraacrylate had a refractive index value of 1.485, while the refractive index was 1.53 for pentaerythritol tetramercaptopropionate; pentaerythritol triacrylate had a refractive index value of 1.48, while the refractive index was 1.50 for pentaerythritol trimercaptopropionate; ethoxylated trimethylolpropane triacrylate had a refractive index value of 1.47, while the refractive index was 1.48 for ethoxylated trimethylolpropane trimercaptopropionate; and ethylene glycol dimethacrylate had a refractive index value of 1.46, while the refractive index was 1.51 for glycol dimercaptopropionate. Unexpectedly, and beneficially, the polythiol compound had a significantly higher refractive index (by 0.01 to 0.05) as compared to structurally similar acrylates.

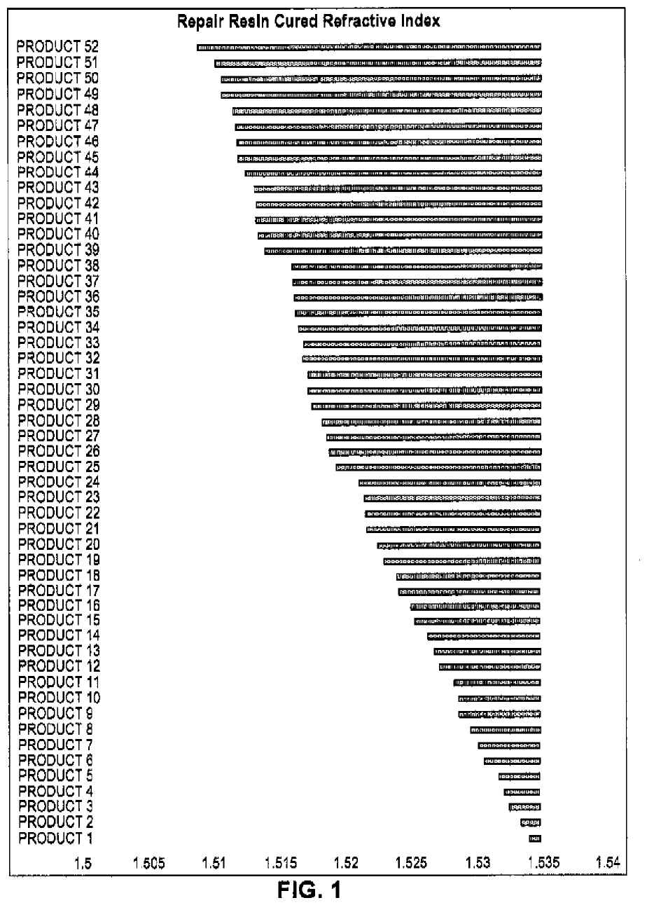

Example 17 is summarized in FIG. 1, in which 52 adhesive products were analyzed, and very few comparative adhesives have a cured refractive index over 1.52, and much less have a refractive index over 1.525. Cured thiol-based adhesives, as described herein, have a refractive index in the 1.53 to 1.54 range, which is a significant improvement in optical performance over traditional windshield repair resins.

TABLE I
Formulations of Examples 1-15 (amounts in grams)

| | | Example | | | | | | | | |
|---|---|---|---|---|---|---|---|---|---|---|
| | | 1 | 2 | 3 | 4 | 5 | 6 | 7 | 8 | 9 |
| Trimethylolpropane | | 0 | 18 | 0 | 0 | 0 | 0 | 0 | 0 | 0 |
| triacrylate | | | | | | | | | | |
| Trimethylolpropane | | 18 | 0 | 18 | 16 | 18 | 18 | 18 | 17 | 15 |
| tris(3-mercaptopropionate) | | | | | | | | | | |
| Pentaerythritol | | 0 | 0 | 0 | 0 | 0 | 0 | 0 | 1 | 3 |
| tetrakis(3-mercaptopropionate) | | | | | | | | | | |
| Tricyclodecane | | 30 | 30 | 27 | 26.7 | 6 | 8 | 10 | 10 | 10 |
| dimethanol diacrylate | | | | | | | | | | |
| Ethoxylated DGEBA diacrylate | | 0 | 0 | 3 | 0 | 24 | 22 | 20 | 20 | 20 |
| Dicyclopentenyl acrylate | | 13.8 | 13.8 | 15 | 20.3 | 12.3 | 12.3 | 12.3 | 12.3 | 12.3 |
| Isobornyl acrylate | | 11 | 11 | 8.3 | 8.3 | 15 | 15 | 15 | 15 | 15 |
| Hydroxyethyl methacrylate | | 20 | 20 | 16.5 | 20 | 18 | 18 | 18 | 18 | 18 |
| Methacryloxypropyl | | 10 | 10 | 10 | 5 | 5 | 5 | 5 | 5 | 5 |
| trimethoxysilane | | | | | | | | | | |
| (adhesion promoter) | | | | | | | | | | |
| 2-(Phosphonooxy)ethylmethacrylate | 50 | 0.5 | 0.5 | 0.5 | 0.5 | 0.5 | 0.5 | 0.5 | 0.5 | 0.5 |
| bis(methacrylotoyloxyethyl)hydrogen | 50 | | | | | | | | | |
| phosphate (stabilizer) | | | | | | | | | | |
| Bis(1,2,2,6,6-pentamethyl- | 50-100 | 0.2 | 0.2 | 0.2 | 0.2 | 0.2 | 0.5 | 0.5 | 0.5 | 0.5 |
| 4-piperidyl)sebacate | | | | | | | | | | |
| Methyl 1,2,2,6,6-pentamethyl-4- | 20-50 | | | | | | | | | |
| piperidyl sebacate (UV inhibitor) | | | | | | | | | | |

| | | | | | | | | | |
|---|---|---|---|---|---|---|---|---|---|
| Methanone, | 1 | 1 | 1 | 0.5 | 0.5 | 0.5 | 0.5 | 0.5 | 0.5 |
| (1-hydroxycyclohexyl)phenyl | | | | | | | | | |
| (photoinitiator) | | | | | | | | | |
| BHT (stabilizer) | 0.5 | 0.5 | 0.5 | 0.5 | 0.5 | 0.5 | 0.5 | 0.5 | 0.5 |
| Acrylic Acid | 0 | 0 | 0 | 1.5 | 0 | 0 | 0 | 0 | 0 |

| | | Example | | | | | |
|---|---|---|---|---|---|---|---|
| | | 10 | 11 | 12 | 13 | 14 | 15 |
| Glycol di(3-mercaptopropionate) | | 0 | 0 | 18 | 15.9 | 0 | 0 |
| Ethoxylated trimethylolpropane | | 0 | 0 | 0 | 0 | 18 | 57.6 |
| tri(3-mercaptopropionate) | | | | | | | |
| Pentaerythritol | | 18 | 16.4 | 0 | 0 | 0 | 0 |
| tetrakis(3-mercaptopropionate) | | | | | | | |
| Tricyclodecane dimethanol | | 8 | 8 | 8 | 8 | 8 | 8 |
| diacrylate | | | | | | | |
| Ethoxylated DGEBA diacrylate | | 22 | 22 | 22 | 22 | 22 | 22 |
| Dicyclopentenyl acrylate | | 12.3 | 13.9 | 12.3 | 12.3 | 12.3 | 10.7 |
| Isobomyl acrylate | | 15 | 15 | 15 | 15 | 15 | 0 |
| Hydroxyethyl methacrylate | | 18 | 18 | 18 | 18 | 20.1 | 0 |
| Methacryloxypropyl trimethoxysilane | | 5 | 5 | 5 | 5 | 5 | 0 |
| 2-(Phosphonooxy)ethylmethacrylate | 50 | 0.5 | 0.5 | 0.5 | 0.5 | 0.5 | 0.5 |
| bis(methacryloloyloxyethyl)hydrogen | 50 | | | | | | |
| phosphate | | | | | | | |
| Bis(1,2,2,6,6-pentamethyl-4- | 50-100 | 0.2 | 0.2 | 0.2 | 0.2 | 0.2 | 0.5 |
| piperidyl)sebacate | | | | | | | |
| Methyl 1,2,2,6,6-pentamethyl-4- | 20-50 | | | | | | |
| piperidyl sebacate | | | | | | | |

| | | | | | | |
|---|---|---|---|---|---|---|
| Methanone, | 1 | 1 | 1 | 0.5 | 0.5 | 0.5 |
| (1-hydroxycyclohexyl)phenyl | | | | | | |
| BHT | 0.5 | 0.5 | 0.5 | 0.5 | 0.5 | 0.5 |

TABLE II
Properties of Examples 1-15

| | Example | | | | | | | | |
|---|---|---|---|---|---|---|---|---|---|
| | 1 | 2 | 3 | 4 | 5 | 6 | 7 | 8 | 9 |
| Gel time (sec) | 25 | <4 | 21 | 38 | 32 | 38 | 38 | 33 | 33 |
| Adhesion evaluation | Ok | Ok | Ok | Ok | Ok | Ok | Ok | Ok | Ok |
| Refractive Index (uncured) | 1.4895 | 1.4826 | 1.4895 | 1.4877 | 1.4973 | 1.4963 | 1.4953 | 1.4971 | 1.4968 |
| Viscosity | 25.1 | 23.7 | 24.7 | 19.8 | 32.6 | 32.9 | 31.3 | 31.9 | 31.9 |
| (60 rpm, 22.5° C., cP) | | | | | | | | | |
| Refractive Index | 1.5305 | 1.5244 | 1.5330 | 1.5308 | 1.5370 | 1.5367 | 1.5351 | 1.5350 | 1.5357 |
| (cured, average) | | | | | | | | | |
| Refractive Index | 3.5 | 3.5 | 4 | 4 | 5 | 7 | 7 | 5 | 5 |
| (cured resin thickness, mils) | | | | | | | | | |
| Glass Adhesion Strength (psi) | 4790 | 850 | 2000 | — | 4314 | — | 4200 | — | — |
| Glass Adhesion (type of break) | A/G | A | A | — | A/C | — | A/C | — | — |
| A = Adhesive | | | | | | | | | |
| C = Cohesive | | | | | | | | | |
| Linear Shrinkage (%) | 6.5 | 2.3 | — | — | — | — | — | 4.56 | 4.85 |

| | Example | | | | | |
|---|---|---|---|---|---|---|
| | 10 | 11 | 12 | 13 | 14 | 15 |
| Gel time (sec) | 34 | 32 | 58 | 45 | 18 | 14 |
| Adhesion evaluation | Ok | Ok | Ok | Ok | Ok | X |
| Refractive Index (uncured) | 1.4897 | 1.4897 | 1.4954 | 1.4937 | 1.4916 | 1.5024 |
| Viscosity | 36.7 | 36.6 | 21.3 | 20.5 | 46.9 | 330 |
| (60 rpm, 22.5° C., cP) | | | | | | |
| Refractive Index | 1.5386 | 1.5364 | 1.5363 | 1.5367 | 1.5272 | 1.5389 |
| (cured, average) | | | | | | |
| Refractive Index | 6-7 | 4-6 | 4-10 | 8 | 6-8 | 8 |
| (cured resin thickness, mils) | | | | | | |
| Glass Adhesion Strength (psi) | 3593 | 3120 | 3410 | 2340 | 3542 | <1000 |
| Glass Adhesion (type of break) | A/C | A/C | A/C | A/C | A | A |
| A = Adhesive | | | | | | |
| C = Cohesive | | | | | | |
| Linear Shrinkage (%) | 4.34 | 4.65 | 6.57 | 5.22 | 3.07 | 2.42 |

1-62. (canceled)

63. An adhesive composition comprising:
(i) a polythiol compound;
(ii) a (meth)acrylate monomer and/or a (meth)acrylate oligomer;
(iii) a photoinitiator;
(iv) a stabilizer comprising an antioxidant component, an acidic component, or any combination thereof; and
(v) an adhesion promoter; wherein:
the composition has a Brookfield viscosity at 22.5° C. in a range from about 5 to about 100 cP.

64. The composition of claim 63, wherein the polythiol compound comprises 1,2-ethanedithiol, 1,8-dimercapto-3,6-dioxaoctane, glycol di(3-mercaptopropionate), trimethylolpropane tris(3-mercaptopropionate), pentaerythritol tetrakis(3-mercaptopropionate), dipentaerythritol hexakis(3-mercaptopropionate), ditrimethylolpropane tetrakis(3-mercaptopropionate), glycol dimercaptoacetate, trimethylolpropane trimercaptoacetate, pentaerythritol tetramercaptoacetate, an ethoxylated trimethylolpropane tris(3-mercaptopropionate), propylene glycol (3-mercaptopropionate), 2,3-di((2-mercaptoethyl)thio)-1-propanethiol, dimercaptodiethylsulfide, tris[2-(3-mercaptopropionyloxy)ethyl]isocyanurate, pentaerythritol tetrakis(thioglycolate), pentaerythritol tetrakis(3-mercaptopropyl ether), or any combination thereof.

65. The composition of claim 63, wherein the polythiol compound contains three or four thiol (—SH) groups.

66. The composition of claim 63, wherein the stabilizer comprises hydroquinone, p-tert-butyl catechol, 2,6-ditert-butyl-p-methylphenol, phenothiazine, N-phenyl-2-naphthylamine, butylated hydroxytoluene (BHT), or any combination thereof.

67. The composition of claim 63, wherein the stabilizer comprises a phosphorus-containing acid, an organic acid, acrylic acid, methacrylic acid, maleic acid, fumaric acid, cinnamic acid, cyanoacetic acid, barbituric acid, citric acid, ascorbic acid, or any combination thereof.

68. The composition of claim 63, wherein the composition comprises from about 5 to about 75 wt. % of the polythiol compound.

69. The composition of claim 63, wherein the composition comprises from about 50 to about 85 wt. % of the (meth)acrylate monomer and/or the (meth)acrylate oligomer.

70. The composition of claim 63, wherein the composition comprises:
from about 100 ppm to about 2 wt. % of the photoinitiator; and
from about 100 ppm to about 2 wt. % of the stabilizer.

71. The composition of claim 63, wherein the composition further comprises an olefin compound at a weight ratio of the (meth)acrylate monomer and/or the (meth)acrylate oligomer to the olefin compound in a range from about 1:1 to about 10:1.

72. The composition of claim 63, wherein the composition further comprises a UV inhibitor.

73. The composition of claim 72, wherein the composition comprises from about 100 ppm to about 2 wt. % of the UV inhibitor.

74. The composition of claim 63, wherein:
the adhesion promoter comprises a silane; and
the composition comprises from about 1 to about 18 wt. % of the adhesion promoter.

75. The composition of claim 63, wherein:
the Brookfield viscosity at 22.5° C. is in a range from about 12 to about 45 cP;
the composition has a refractive index in a range from about 1.48 to about 1.495; and
the composition is shelf-stable for at least 2 months at 25° C. and 1 atm.

76. A cured adhesive produced from the composition of claim 63.

77. The adhesive of claim 76, wherein the cured adhesive has a refractive index in a range from about 1.53 to about 1.54.

78. An article of manufacture comprising a substrate partially filled with the cured adhesive of claim 76, wherein the substrate comprises glass.

79. A method for repairing a damaged area of a windshield, the method comprising:
(A) introducing the composition of claim 63 into the damaged area; and
(B) curing the composition to repair the damaged area of the windshield.

80. The method of claim 79, wherein:
step (A) and/or step (B) is/are conducted a temperature in a range from about 10 to about 35° C.; and
step (B) is conducted for a time period in a range from about 30 seconds to about 2 hours.

81. The method of claim 79, wherein an amount of the composition introduced in step (A) is in a range from about 0.05 to about 0.15 grams.

82. A repaired windshield formed by the method of claim 79.
